(19) United States
(12) Patent Application Publication
(10) Pub. No.: US 2026/0081857 A1
(43) Pub. Date: Mar. 19, 2026

(54) Adaptive Flow Control of a gNMI-based Telemetry Session

(71) Applicant: Ciena Corporation, Hanover, MD (US)

(72) Inventors: Ashutosh Maheshwari, Gurugram (IN); Shubham Mishra, Kanpur (IN); Sourabh Jain, Delhi (IN); Shalendra Tripathi, Gurugram (IN)

(73) Assignee: Ciena Corporation, Hanover, MD (US)

(21) Appl. No.: 18/928,710

(22) Filed: Oct. 28, 2024

(30) Foreign Application Priority Data
Sep. 13, 2024 (IN) 202411069363

(51) Int. Cl. H04L 43/0876; H04L 47/25

(52) U.S. Cl. CPC H04L 43/0876; H04L 47/25

(57) ABSTRACT

Systems and methods provide adaptive flow control of a gRPC Network Management Interface (gNMI)-based telemetry session at a gNMI server. A method includes receiving a telemetry subscription from a gNMI client for telemetry from the gNMI server; determining a sample interval for the telemetry subscription; and, based on the sample interval either performing (1) regular streaming via gNMI of the telemetry subscription or (2) adaptive streaming via gNMI of the telemetry subscription where the sample interval is periodically updated.

### FIELD OF THE DISCLOSURE

The present disclosure relates generally to networking and computing. More particularly, the present disclosure relates to systems and methods for adaptive flow control of a gRPC Network Management Interface (gNMI)-based telemetry session.

### BACKGROUND OF THE DISCLOSURE

gNMI is a network management protocol designed to provide a standardized method for managing and monitoring network devices. It leverages gRPC for communication, offering a more efficient and scalable approach compared to traditional management protocols like Simple Network Management Protocol (SNMP). Note, gRPC started as an abbreviation of Google Remote Procedure Call. However, since gRPC became an open-source project in 2015, the “g” is no longer officially tied to Google and can be interpreted as general-purpose or generic, e.g., generic or general-purpose Remote Procedure Call. gNMI is particularly useful in environments requiring real-time telemetry data and configuration management, enabling network operators to collect detailed, structured data from devices and apply configuration changes programmatically. This protocol supports both streaming and on-demand data retrieval, making it ideal for dynamic and large-scale network environments where automation and high precision are critical. There are various scenarios where a gNMI service can breakdown, thereby causing a loss or slowdown of telemetry data from network elements.

### BRIEF SUMMARY OF THE DISCLOSURE

The present disclosure relates to systems and methods for Adaptive Flow Control of a gRPC Network Management Interface (gNMI)-based Telemetry Session. To address the various scenarios where a gNMI service may breakdown, the present disclosure introduces a flow control mechanism to control the streaming data rate based on dynamic conditions of a server. Also, adaptive tuning parameters are included, such as units of time and number of iterations to drive the adaptive engine. Advantageously, the approach described herein controls the source of data streaming to ensure no data loss. Also, this provides a flexible subscription to sample telemetry which is advantageous when managing a pool of network elements. For example, a user wants to subscribe to all the network elements with the same set of subscription configuration irrespective of the scale of the sensors and system resources available to the system by specifying sample interval as “0” and subscription mode as “sample”.

In various embodiments, the present disclosure includes a method having steps, an apparatus configured to implement the steps, and a non-transitory computer-readable medium storing instructions that, when executed, cause one or more processors to implement the steps. The steps provide adaptive flow control of a gRPC Network Management Interface (gNMI)-based telemetry session at a gNMI server. The steps include receiving a telemetry subscription from a gNMI client for telemetry from the gNMI server; determining a sample interval for the telemetry subscription; and, based on the sample interval either performing (1) regular streaming via gNMI of the telemetry subscription or (2) adaptive streaming via gNMI of the telemetry subscription where the sample interval is periodically updated.

In an embodiment, the sample interval can be a non-zero value, and the steps include streaming out a current value of the telemetry and noting a time Ti which is a time taken to stream out the current value; performing the regular streaming if Ti is less than or equal to the sample interval; and sending an error and terminating the telemetry subscription if Ti is greater than the sample interval. In another embodiment, the sample interval can be zero, and the steps include streaming out a current value of the telemetry and noting a time Ti which is a time taken to stream out the current value; setting the sample interval Ts to Ti; and performing the adaptive streaming where sample interval Ts is periodically updated. The either performing can include the (1) regular streaming when the sample interval is a non-zero value or the (2) adaptive streaming when the sample interval is zero.

The adaptive streaming can include updating the sample interval every N samples, N being an integer, wherein the updating incorporates load and scale of the gNMI server to adjust the sample interval. The adaptive streaming can include setting an initial value of the sample interval; performing streaming of N samples, N being an integer, and determining a time value of each of the N samples; and after the N samples, determining an updated sample interval based on the determined time value of each of the N samples. The updated sample interval can be an average of the determined time value of each of the N samples plus or minus an adaptive tuning parameter. The telemetry subscription can be one of a plurality of telemetry subscriptions between the gNMI server and the gNMI client, and wherein the performing (1) regular streaming or (2) adaptive streaming is performed independently for each of the plurality of telemetry subscriptions. The gNMI server can be a network element, and the gNMI client can be a management system.

### BRIEF DESCRIPTION OF THE DRAWINGS

The present disclosure is detailed through various drawings, where like components or steps are indicated by identical reference numbers for clarity and consistency.

FIG. 1 illustrates a network with a management system and multiple network elements for illustrating gNMI base telemetry sessions.

FIGS. 2A and 2B illustrate a flowchart of a process for adaptive flow control of a gNMI-based telemetry session.

FIG. 3 illustrates a block diagram of a network element, depicted in a simplified functional format.

FIG. 4 illustrates a block diagram of an example processing device.

FIG. 5 illustrates a flowchart of adaptive flow control of a gRPC Network Management Interface (gNMI)-based telemetry session.

### DETAILED DESCRIPTION OF THE DISCLOSURE

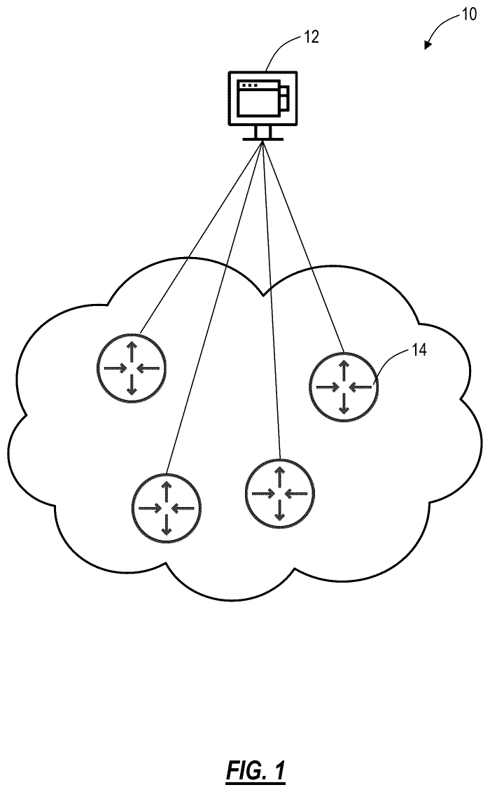

Again, the present disclosure relates to systems and methods for Adaptive Flow Control of gNMI-based Telemetry Session. FIG. 1 illustrates a network 10 with a management system 12 and multiple network elements 14 for illustrating gNMI base telemetry sessions. The gNMI protocol runs over a Transmission Control Protocol (TCP)/Internet Protocol (IP) connection based gRPC client-server framework. It provides a mechanism for a client/user to subscribe to a resource path, commonly called as sensors, to get periodic updates of the resource or on the event of any change in the state of the resource. In gNMI, a sensor refers to a specific data source or entity on a network element 14 that collects and provides telemetry information. Sensors are essentially monitoring points that can capture various types of data, such as interface statistics, Central Processor Unit (CPU) usage, memory usage, or any other operational state of the network element 14. These sensors are configured on the network element 14 to stream data at specified intervals or when certain thresholds are met. The collected data is then sent to a gNMI client, i.e., the management system 12, which can be used for real-time monitoring, analytics, and automation. Sensors are key to gNMI's ability to provide granular and precise data, enabling efficient network management and troubleshooting. The gNMI client is a software application or tool that interacts with the network elements 14. The client is responsible for sending requests to the network elements 14. to either retrieve telemetry data, apply configuration changes, or both. It acts as the counterpart to the gNMI server or sensor, which runs on the network elements 14 themselves.

The details of the gNMI specification are Borman et al., “gRPC Network Management Interface (gNMI),” May 25, 2023, version 0.10.0, available at: github.com/openconfig/reference/blob/master/rpc/gnmi/gnmi-specification.md, and the contents of which are incorporated by reference in their entirety.

In networking and network management, gNMI enables efficient communication between the management system 12, e.g., a Network Management System (NMS), and the network elements 14, such as routers, switches, and the like. The NMS, acting as the gNMI client, interacts with the network elements 14, which serve as gNMI servers or sensors, to retrieve data and apply configuration changes. Through operations like Get and Subscribe, the NMS can request specific data or receive real-time telemetry streams from the network elements, allowing continuous monitoring of network performance. The Set operation allows the NMS to push configuration changes to the network elements, ensuring that the network remains up-to-date and consistent.

This protocol offers several advantages, including scalability, real-time data access, and automation, making it ideal for managing large and dynamic networks. By using gNMI, the NMS can maintain an accurate, real-time view of the network's health, automate configuration tasks, and respond quickly to changes, all within a standardized and secure framework. This streamlines network management, enhances operational efficiency, and supports the increasingly complex demands of modern networks.

As described herein, a gNMI client is the management system 12, and a gNMI sensor or server is the network element 14.

### Problem Statement

Based on operation of gNMI services in a network, there are a variety of scenarios where there was a breakdown in the gNMI service, such as:
(1) The underlying gRPC server layer puts a backpressure on a gNMI server application when the gNMI client is slow in absorbing the gNMI notifications sent from the gNMI server application. The sensor applications, however, continue to publish periodic updates for the client as per the subscription contract. This triggers a Head-of-line (HOL) blocking at the server side. This eventually leads to Out of Memory (OOM) of the gNMI server application and service goes down.
(2) When a gNMI client makes a sample subscription of a large size resource without specifying a sufficiently large sample interval (or with sample-interval 0), the gNMI server application ends up generating a large scale of update notifications. The next sample arrives before the last sample data is completely streamed out of device. This causes queuing of updates held at the server application, which results into OOM of the gNMI server application and service goes down.
(3) When a gNMI client subscribes in a target-defined mode, the gNMI server is expected to send the response as soon as possible. If the default operational mode of the sensor is sample, then also the above scenarios are applicable. In gNMI, the target-defined mode allows the device (target) to determine how data is structured and presented to the client, rather than the client specifying the exact paths or data points. This mode provides flexibility for the device to optimize data reporting based on its capabilities, which is particularly useful in complex systems. It reduces the need for detailed client configuration, making it ideal for telemetry or subscription scenarios where the device manages the flow of information to ensure efficient data delivery.
(4) When the server is busy doing other important tasks and experiencing a high CPU utilization, any extra work like sending sample stats at regular interval adds complexity.
(5) Data streaming with a specific frequency on one platform results in OOM on a low memory platform.

The above scenarios can be exploited in a Denial-of-Service (DOS) attack as well, requiring protection of the network elements 14 and the management system 12.

gNMI Sample Intervals

The gNMI client can subscribe multiple times with varying sample intervals during data collection whenever there is a service breakdown due to no rate limiting present on the server side. The gNMI client can subscribe with a sufficiently high sample interval which can be derived with few iterations. The gNMI client may experience service breakdown multiple times during data collection, due to dynamic conditions of the server at various point of time. The gNMI client must derive a sufficiently large sample interval at its own which can be used to stream the data without any service disruption. The gNMI client may receive data at a slower rate due to arbitrarily large sample interval configured to stream data. This can affect its ability to take decisions based on the received data in real time. The gNMI client may have to subscribe to each device with different sample interval and must keep track of each.

In gNMI, the sample interval defines how frequently telemetry data is sampled and sent from the network element 14 to the management system 12. Configured in nanoseconds, this interval is crucial in sampled subscription modes, where data is collected at regular intervals (e.g., every 10 seconds). The choice of sample interval balances data granularity and bandwidth usage; shorter intervals offer more detailed, real-time data but increase network and processing demands, while longer intervals reduce these demands but provide less frequent updates. When the sample interval in gNMI is set to zero, the network element 14 streams telemetry data continuously or at the highest possible frequency without delay between samples. This can significantly increase network traffic and processing demands, potentially overwhelming both the device and the receiving system.

### Proposed Solution

Again, in the network 10, the management system 12 as the gNMI client can subscribe to multiple telemetry subscriptions on the network elements 14, as the gNMI server or sensor. As such, the network element 14 as the gNMI server sends events based thereon, and there can be multiple subscriptions on each network element. The objective is to ensure a problematic gNMI service does not affect other gNMI services.

The present disclosure introduces a flow-control mechanism in gNMI to control the streaming data rate based on the dynamic conditions of the network element 14 (the gNMI server). Adaptive tuning parameters are used and are units of time and number of iterations to drive the adaptive engine, to control the source of data streaming in a way that can be handled without any data loss.

Advantageously, the approach described herein include data streaming that is adaptive to the condition of the system (e.g., CPU load, memory, scale, etc.). There is no data loss due to the changing frequency of sampling. Each client session related adaptive tuning is mutually exclusive to other client sessions. The adaptive tuning parameters are configurable suitable for a specific field scenario.

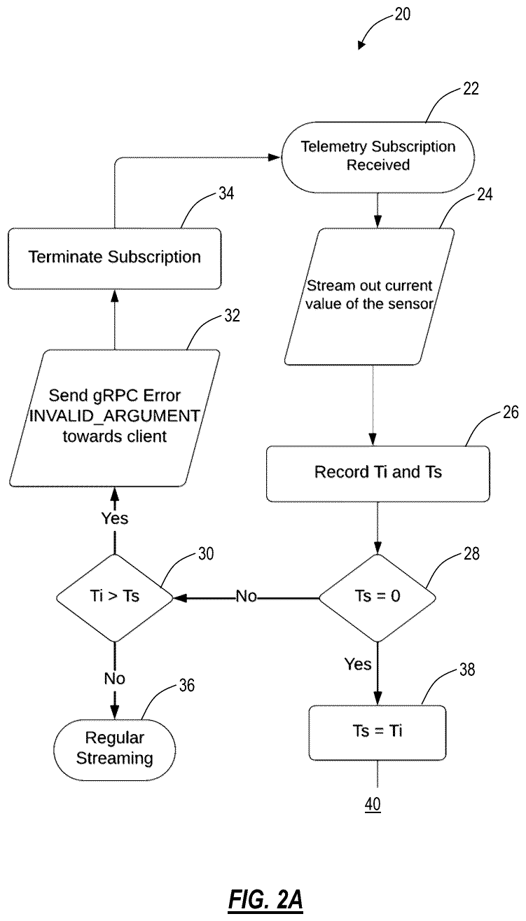

FIGS. 2A and 2B illustrate a flowchart of a process 20 for adaptive flow control of a gNMI-based telemetry session. The process 20 contemplates implementation as a method having steps, via an apparatus, such as the gNMI client, the network element 14, etc., configured to implement the steps, and as a non-transitory computer-readable medium storing instructions that, when executed, cause processing circuitry to implement the steps. The following variables are used in the process 20:

| | |
|---|---|
| Ti | Time taken to stream out current value starting immediately |
| | after the subscription is received |
| Ts | Sample interval as received in the subscription request |
| Tp | Time difference between the time of sending first and last |
| | update for one periodic sample |
| Ta | Average time of Tp recorded over N samples |
| Td | Adaptive tuning parameter for time units (second), used |
| | to adjust the sample interval dynamically |
| N | Adaptive tuning parameter for number of samples, used to |
| | record Tp over N samples |

The process 20 includes receiving a telemetry subscription (step 22). Again, the gNMI server (the network element 14) can receive multiple telemetry subscriptions from the gNMI client (the management system 12) for anything measurable by the network element 14. Non-limiting examples of telemetry include processor utilization, memory utilization, bandwidth utilization, Performance Monitoring (PM) measurements, operating statistics, Key Performance Indicators (KPIs), Operations, Administration, Maintenance, and Provisioning (OAM & P) data, and the like. That is, telemetry as used herein is a measured value at the network element 14 (gNMI server) that the management system 12 (gNMI client) wants to receive as a sample interval. That is, the telemetry subscription includes the telemetry desired along with the sample interval, i.e., how often the telemetry should be sent to the management system 12 using gNMI.

Again, the gNMI server and the gNMI client need an adaptive solution to flow-control the rate of updates per client per subscription. The solution should adapt to the network conditions and decrease/increase/maintain the flow of updates from the gNMI server dynamically and prevent telemetry service disruption or any loss of information.

After receiving the telemetry subscription (step 22), the gNMI server streams out a current value of the sensor (step 24). Here, the sensor is used to denote the measurement of the telemetry. The process 20 include recording values of Ti and Ts (step 26). Again, Ti is the time taken to stream out current value starting immediately after the subscription is received, and Ts is the sample interval as received in the subscription request.

The process 20 includes checking if the sample interval Ts is set to zero (step 28). If Ts does not equal zero (step 28), the telemetry subscription has a defined sample interval. The process 20 includes checking if Ti>Ts (step 30), i.e., whether or not the sample interval is greater than the time it takes to stream out a current value. If Ti>Ts (step 30), then the telemetry subscription is invalid, and a gRPC error with an INVALID_ARGUMENT is sent to the gNMI client (step 32), and the telemetry subscription is terminated (step 34). If Ti≤Ts (step 30), the process 30 includes regular streaming for this telemetry subscription (step 36). That is, the telemetry subscription has a sample interval that can be met and regular gNMI streaming is possible.

When Ts=0 (step 28), the network element 14 streams telemetry data continuously or at the highest possible frequency without delay between samples. It is in this regime that the process 20 introduces adaptive flow control. First, the process 20 includes setting the sample interval Ts equal to Ti (step 38), i.e., even though the sample interval is zero, the network element 14 can only stream at Ti.

The process 20 includes adaptive flow control to dynamically adjust the value of Ts (step 40 which extends from FIG. 2A to FIG. 2B). In adaptive streaming (step 42), the process 20 includes continually streaming the telemetry and recording Tp for each sample. Again, Tp is the time difference between the time of sending first and last update for one periodic sample. Ideally, if the device were perfect and Ti is the fastest it could send, Tp would be Ti. Of course, in operation, the values of Tp will vary as device load varies.

The process 20 will take N samples and associated Tp values (step 44). The value of N can be some predetermined value and the smaller value means the adaptation of the sample interval will change faster. After N samples (step 44), the process 20 includes calculating Ta which is the average time of Tp recorded over the N samples (step 46), i.e., Ta=(ΣTp)/N. This value of Ta is used to adjust the sample interval Ts. Again, the initial sample interval is set to Ti, but with this adaptive flow control and adaptive streaming, the value of Ts can change every N samples.

The process 20 includes checking Ta relative to the current Ts (step 48). If Ta>Ts (step 48), then the process 20 includes adjusting Ts to be Ta plus an adaptive tuning parameter (Td) which is some predetermined time used to adjust the sample interval dynamically (step 50). This new value of Ts is sent to the sensor application at the gNMI server to reconfigure the periodic timers for this telemetry subscription.

If Ta≤Ts (step 48), then the process 20 includes adjusting Ts to be Ta minus the adaptive tuning parameter (Td) (step 54), and this new value of Ts is sent to the sensor application at the gNMI server to reconfigure the periodic timers for this telemetry subscription (step 56).

After steps 52, 56, the process 20 includes a new value for Ts and the adaptive streaming continues back at step 42.

The change in sample interval will reflect in the timestamp of gNMI update packet and in the output of a CLI command. An event shall be sent on each such change to keep the subscriber updated.

Benefits of this Approach Include:
(1) The data streaming is adaptive to the condition of the gNMI server (CPU load, memory, scale, etc.).
(2) There is no data loss due to the changing frequency of sampling.
(3) Each telemetry session related adaptive tuning is mutually exclusive to the other telemetry sessions.
(4) The adaptive tuning parameters are configurable suitable for specific field scenarios.
(5) The solution brings in a flow-control mechanism to control the streaming data rate based on the dynamic conditions of the server system.
(6) The solution uses adaptive tuning parameters, i.e., units of time and number of iterations to drive the adaptive engine.
(7) The solution controls the source of data streaming in a way that can be handled without any data loss.

It is a unique feature and advantageous when managing a pool of network elements 14 and a user wants to subscribe to all the network elements 14 with the same set of subscription configuration irrespective of the scale of the sensors and system resources available to the system by specifying sample interval as “0” and subscription mode as “sample”. This enables the user to not have to set a specific sample interval and lets the system itself adjust accordingly.

### Example Node

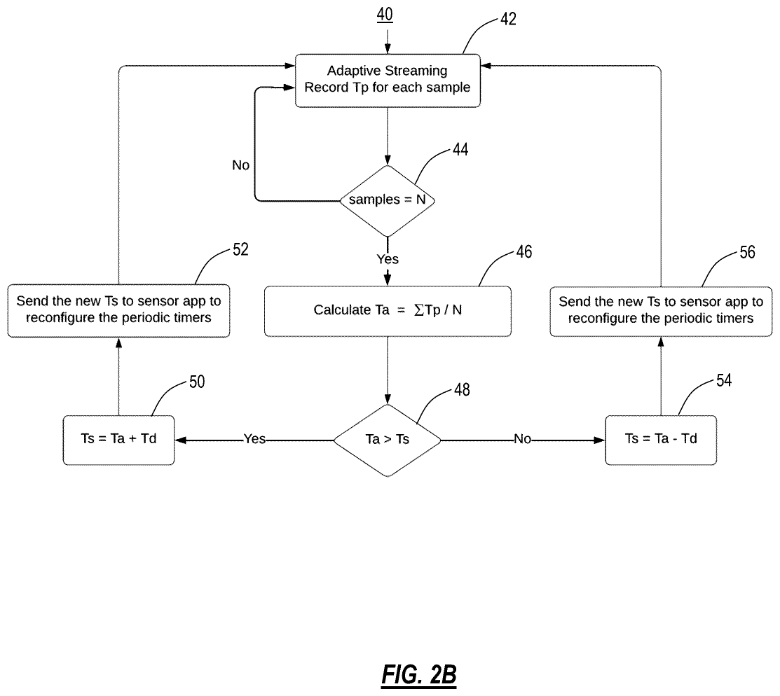

FIG. 3 is a block diagram of a network element 14, depicted in a simplified functional format. It is important to note that a more practical design of this router would likely include additional components and processing logic to accommodate standard operating features, which are not detailed here. The network element 14100 may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 14. It may also communicate with external network management systems or databases that handle provisioning and operational data.

Lastly, while FIG. 3 provides a basic view, those skilled in the art will understand that the network element 14 could include additional components or be configured differently, such as in a distributed arrangement or as an integrated, rack-mounted unit (often referred to as a “pizza-box” configuration). This depiction in FIG. 3 is intended to convey functional aspects, with actual hardware implementations varying widely.

### Example Processing Device

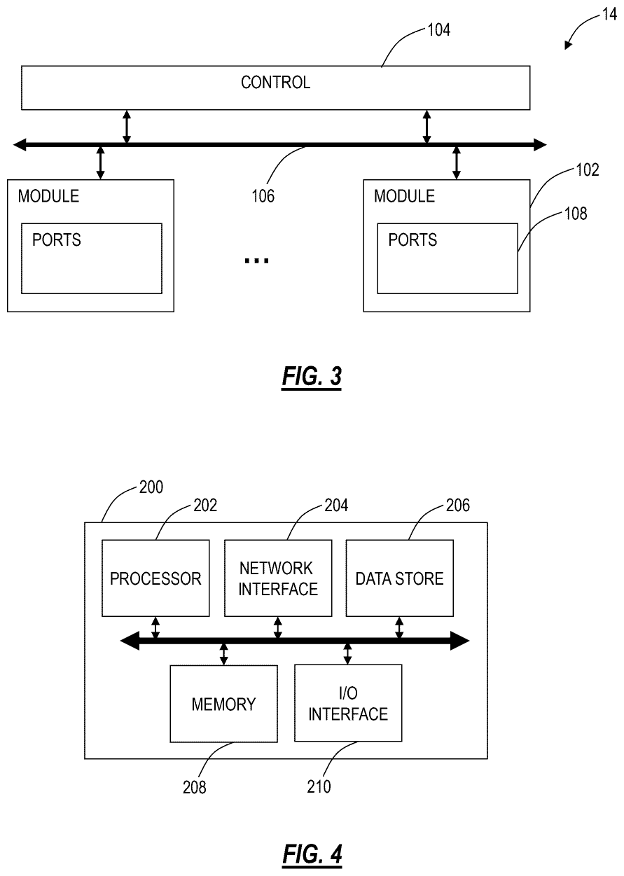

FIG. 4 is a block diagram of an example processing device 200. The processing device 200 may be integrated within the network element 14 or function as a standalone unit connected to the network element 14, including the management system 12. It may also be known as an apparatus, a control module, shelf controller, shelf processor, or system controller. The core of the processing device 200 is a processing unit 202, a hardware unit that runs software instructions. The processing unit 202 could be one or more custom or commercially available processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, OAM & P data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices. When the processing device 200 is the management system 12, the network interface 204 is communicatively coupled to the network elements 14 in network.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Process

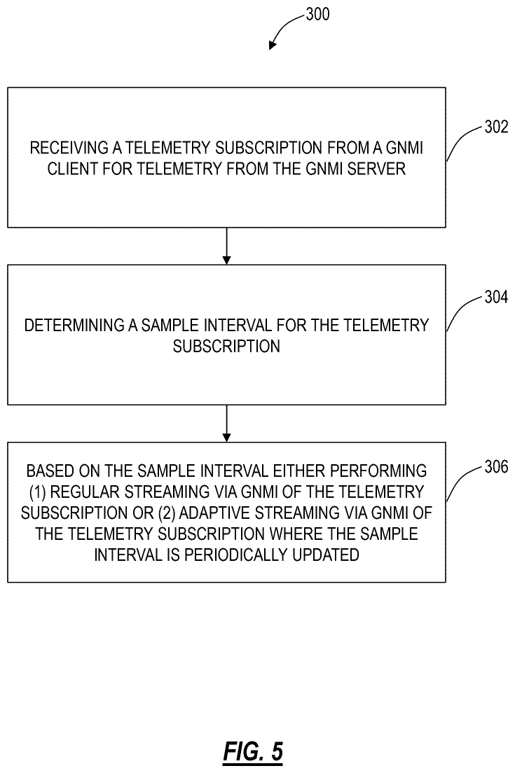

FIG. 5 illustrates a flowchart of a process 300 of adaptive flow control of a gRPC Network Management Interface (gNMI)-based telemetry session. The process 300 contemplates implementation at a gNMI server, e.g., a network element 12. Further, the process 300 can be realized as a method having steps, via an apparatus configured to implement the steps, and as a non-transitory computer-readable medium storing instructions that, when executed, cause one or more processors to implement the steps.

The process 300 includes receiving a telemetry subscription from a gNMI client for telemetry from the gNMI server (step 302); determining a sample interval for the telemetry subscription (step 304); and, based on the sample interval either performing (1) regular streaming via gNMI of the telemetry subscription or (2) adaptive streaming via gNMI of the telemetry subscription where the sample interval is periodically updated (step 306).

The sample interval can be a non-zero value, and the process 300 includes streaming out a current value of the telemetry and noting a time Ti which is a time taken to stream out the current value; performing the regular streaming if Ti is less than or equal to the sample interval Ts; and sending an error and terminating the telemetry subscription if Ti is greater than the sample interval. The sample interval can be zero, and the process 300 includes streaming out a current value of the telemetry and noting a time Ti which is a time taken to stream out the current value; setting the sample interval Ts to Ti; and performing the adaptive streaming where the sample interval Ts is periodically updated.

The either performing includes the (1) regular streaming when the sample interval is a non-zero value or the (2) adaptive streaming when the sample interval is zero. The adaptive streaming includes updating the sample interval every N samples, N being an integer, wherein the updating incorporates load and scale of the gNMI server to adjust the sample interval.

In an embodiment, the adaptive streaming includes setting an initial value of the sample interval; performing streaming of N samples, N being an integer, and determining a time value of each of the N samples; and, after the N samples, determining an updated sample interval based on the determined time value of each of the N samples. The updated sample interval is an average of the determined time value of each of the N samples plus or minus an adaptive tuning parameter.

The telemetry subscription can be one of a plurality of telemetry subscriptions between the gNMI server and the gNMI client, and wherein the performing (1) regular streaming or (2) adaptive streaming is performed independently for each of the plurality of telemetry subscriptions. The gNMI server can be a network element, and the gNMI client can be a management system.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A method of adaptive flow control of a gRPC Network Management Interface (gNMI)-based telemetry session at a gNMI server, the method comprising steps of:
receiving a telemetry subscription from a gNMI client for telemetry from the gNMI server;
determining a sample interval for the telemetry subscription; and
based on the sample interval either performing (1) regular streaming via gNMI of the telemetry subscription or (2) adaptive streaming via gNMI of the telemetry subscription where the sample interval is periodically updated.

2. The method of claim 1, wherein the sample interval is a non-zero value, and wherein the steps include
streaming out a current value of the telemetry and noting a time Ti which is a time taken to stream out the current value;
performing the regular streaming if Ti is less than or equal to the sample interval; and
sending an error and terminating the telemetry subscription if Ti is greater than the sample interval.

3. The method of claim 1, wherein the sample interval is zero, and wherein the steps include
streaming out a current value of the telemetry and noting a time Ti which is a time taken to stream out the current value;
setting the sample interval Ts to Ti; and
performing the adaptive streaming where sample interval Ts is periodically updated.

4. The method of claim 1, wherein the either performing includes the (1) regular streaming when the sample interval is a non-zero value or the (2) adaptive streaming when the sample interval is zero.

5. The method of claim 1, wherein the adaptive streaming includes updating the sample interval every N samples, N being an integer, wherein the updating incorporates load and scale of the gNMI server to adjust the sample interval.

6. The method of claim 1, wherein the adaptive streaming includes
setting an initial value of the sample interval;
performing streaming of N samples, N being an integer, and determining a time value of each of the N samples; and
after the N samples, determining an updated sample interval based on the determined time value of each of the N samples.

7. The method of claim 6, wherein the updated sample interval is an average of the determined time value of each of the N samples plus or minus an adaptive tuning parameter.

8. The method of claim 1, wherein the telemetry subscription is one of a plurality of telemetry subscriptions between the gNMI server and the gNMI client, and wherein the performing (1) regular streaming or (2) adaptive streaming is performed independently for each of the plurality of telemetry subscriptions.

9. The method of claim 1, wherein the gNMI server is a network element, and the gNMI client is a management system.

10. A non-transitory computer-readable medium storing instructions for adaptive flow control of a gRPC Network Management Interface (gNMI)-based telemetry session at a gNMI server, the instructions, when executed, cause one or more processors to perform steps of:
receiving a telemetry subscription from a gNMI client for telemetry from the gNMI server;
determining a sample interval for the telemetry subscription; and
based on the sample interval either performing (1) regular streaming via gNMI of the telemetry subscription or (2) adaptive streaming via gNMI of the telemetry subscription where the sample interval is periodically updated.

11. The non-transitory computer-readable medium of claim 10, wherein the sample interval is a non-zero value, and wherein the steps include
streaming out a current value of the telemetry and noting a time Ti which is a time taken to stream out the current value;
performing the regular streaming if Ti is less than or equal to the sample interval; and
sending an error and terminating the telemetry subscription if Ti is greater than the sample interval.

12. The non-transitory computer-readable medium of claim 10, wherein the sample interval is zero, and wherein the steps include
streaming out a current value of the telemetry and noting a time Ti which is a time taken to stream out the current value;
setting the sample interval Ts to Ti; and
performing the adaptive streaming where the sample interval Ts is periodically updated.

13. The non-transitory computer-readable medium of claim 10, wherein the either performing includes the (1) regular streaming when the sample interval is a non-zero value or the (2) adaptive streaming when the sample interval is zero.

14. The non-transitory computer-readable medium of claim 10, wherein the adaptive streaming includes updating the sample interval every N samples, N being an integer, wherein the updating incorporates load and scale of the gNMI server to adjust the sample interval.

15. The non-transitory computer-readable medium of claim 10, wherein the adaptive streaming includes
setting an initial value of the sample interval;
performing streaming of N samples, N being an integer, and determining a time value of each of the N samples; and
after the N samples, determining an updated sample interval based on the determined time value of each of the N samples.

16. The non-transitory computer-readable medium of claim 15, wherein the updated sample interval is an average of the determined time value of each of the N samples plus or minus an adaptive tuning parameter.

17. The non-transitory computer-readable medium of claim 10, wherein the telemetry subscription is one of a plurality of telemetry subscriptions between the gNMI server and the gNMI client, and wherein the performing (1) regular streaming or (2) adaptive streaming is performed independently for each of the plurality of telemetry subscriptions.

18. The non-transitory computer-readable medium of claim 10, wherein the gNMI server is a network element, and the gNMI client is a management system.

19. An apparatus configured to perform adaptive flow control of a gRPC Network Management Interface (gNMI)-based telemetry session performed at a gNMI server associated with the apparatus, the apparatus comprising circuitry configured to:
receive a telemetry subscription from a gNMI client for telemetry from the gNMI server,
determine a sample interval for the telemetry subscription. and
based on the sample interval either perform (1) regular streaming via gNMI of the telemetry subscription or (2) adaptive streaming via gNMI of the telemetry subscription where the sample interval is periodically updated.

20. The apparatus of claim 19, wherein the adaptive streaming includes updating the sample interval every N samples, N being an integer, wherein the updating incorporates load and scale of the apparatus to adjust the sample interval.
